(19) United States
(12) Patent Application Publication
(10) Pub. No.: US 2025/0029097 A1
(43) Pub. Date: Jan. 23, 2025

(54) Method And System For Payment Transaction Approval

(71) Applicant: Rajeev NAIK, Toronto (CA)

(72) Inventor: Rajeev NAIK, Toronto (CA)

(21) Appl. No.: 18/353,666

(22) Filed: Jul. 17, 2023

(51) Int. Cl. G06Q 20/38

(52) U.S. Cl. CPC G06Q 20/3825; G06Q 20/3829

(57) ABSTRACT

A method and system for arranging for authorization of an item, comprising actions of: creating an item request record, comprising information related to an item; digitally signing the item request record; confirming the digital signature of the item request record; submitting an authorization request associated with the item, for authorization by at least one authorizer; securing authorization of the authorization request by the at least one authorizer; generating an authorized item request digitally signed by the at least one authorizer; and validating the digital signature of a next authorizer in the authorization item request until the digital signature(s) of all of the at least one authorizers have been validated. The system may comprise a processor and a computer-readable and executable medium for containing instructions that, when executed by the processor, cause the system to perform the actions of the method.

### TECHNICAL FIELD

The present disclosure relates to payment transactions and in particular to a secure method and system for approving payment transactions

### INTRODUCTION

Increasingly, commercial entities (CE), and the financial institutions (FI) with whom they bank, employ more and more complex approval rules to approve the completion of a payment transaction.

In some non-limiting examples, a typical process for approval of a payment transaction may be shown schematically in FIG. 1. The figure, shown generally at 100, shows a CE 10, an FI associated with the CE (CEFI) 20, a vendor 30, an FI of the vendor (VFI) 40, and a federal clearing house 50.

In some non-limiting examples, the vendor 30 may provide at least one of: a product, and a service, to the CE 10, and thereafter render an invoice, or payment request (CEPR) 500, for payment thereof, to an initiator (CEI) 11 of the CE 10, including without limitation, one of: a bookkeeper, and an accounts payable clerk, of the CE 10, who may be one of: an employee of the CE 10, and an outside contractor of the CE 10.

When the CEPR 500 is received by the CE 10, an approval request (CEAR) 1100 will be submitted by the CEI 11 to at least one approver (CEA) 15 associated with the CE 10 for approval.

In some non-limiting examples, the at least one CEA 15 for a given CEAR 1100 may be specified according to a CE policy 19 of the CE 10. In some non-limiting examples, the CE policy 19 may identify the at least one CEA 15. In some non-limiting examples, the CE policy 19 may specify at least one payment rule that governs payment approval of the CEAR 1100.

In some non-limiting examples, the at least one payment rule may identify a hierarchy of payment approvals. In some non-limiting examples, the hierarchy may comprise a plurality of levels of payment approval and the at least one CEA 15 authorized to approve payment at each level.

In some non-limiting examples, the CE policy 19 may provide that a lower level of payment approval should be completed before seeking approval at a higher level of payment approval. In some non-limiting examples, the CE policy 19 may provide that different levels of payment approval may occur in any order. In some non-limiting examples, a plurality of CEAs 15 may be authorized to approve payment at a given level. In some non-limiting examples, the CE policy 19 may provide that a subset of the plurality of CEAs 15 may approve payment at the associated level. In some non-limiting examples, the CE policy 19 may provide that all of the plurality of CEAs 15 are to approve payment at the associated level.

In some non-limiting examples, at least one of: the at least one payment rule, and the at least one CEA 15, may be varied within the CE policy 19, based on, without limitation, at least one of: a department of the CE 10 for whom the product/service was provided, an amount of the CEAR 1100, a budget category to which the CEAR 1100 is associated, a jurisdiction of the department of the CE 10, a jurisdiction of the vendor 30, a date of the CEAR 1100, and an amount remaining in a budget for the budget category.

In some non-limiting examples, at least one CEA 15e may be external to the CE 10, including without limitation, a director of the CE 10, a lawyer, an accountant, a bookkeeper, an intermediary 13 between the CE 10 and the vendor 30, an employee 15s of at least one second commercial entity (SCE) 12 of which the CE 10 is a subordinate entity, including without limitation, a subsidiary thereof, an officer of the at least one SCE 12, and a director of the at least one SCE 12.

Once the CEAR 1100 is approved according to the CE policy 19, that is, payment is authorized by the CE 10, in some non-limiting examples, the payment request (CEFIPR) is submitted, for payment thereof, to an initiator (CEFII) 21 of the CEFI 20.

When the CEFIPR from the CE 10 is received by the CEFI 20, an approval request (CEFIAR) will be submitted by the CEFII 21 to at least one approver (CEFIA) 25 associated with the CEFI 20 for approval.

In some non-limiting examples, the at least one CEFIA 25 for a given CEFIAR may be specified according to a CEFI policy 29 of the CEFI 20. In some non-limiting examples, the CEFI policy 29 may identify the at least one CEFIA 25. In some non-limiting examples, the CEFI policy 29 may specify at least one payment rule that governs payment approval of the CEFIAR. In some non-limiting examples, the CEFI policy 29 may be specified, including without limitation, in part, by prevailing regulatory requirements in place for the CEFI 20.

In some non-limiting examples, the at least one payment rule may identify a hierarchy of payment approvals. In some non-limiting examples, the hierarchy may comprise a plurality of levels of payment approval and the at least one CEFIA 25 authorized to approve payment at each level.

In some non-limiting examples, the CEFI policy 29 may provide that a lower level of payment approval should be completed before seeking approval at a higher level of payment approval. In some non-limiting examples, the CEFI policy 29 may provide that different levels of payment approval may occur in any order. In some non-limiting examples, a plurality of CEFIAs 25 may be authorized to approve payment at a given level. In some non-limiting examples, the CEFI policy 29 may provide that a subset of the plurality of CEFIAs 29 may approve payment at the associated level. In some non-limiting examples, the CEFI policy 29 may provide that all of the plurality of CEFIAs 25 are to approve payment at the associated level.

In some non-limiting examples, at least one of: the at least one payment rule, and the at least one CEFIA 25, may be varied within the CEFI policy 29, based on, without limitation, at least one of: a department of the CEFI 20 responsible for the banking of the CE 10, an amount of the CEFIAR, an account to which the CEFIAR is associated, a jurisdiction of the department of the CEFI 20, a jurisdiction of the CE 10, a jurisdiction of the vendor 30, a date of the CEFIAR, and an amount remaining in the account.

In some non-limiting examples, at least one CEFIA 25e may be outside the CEFI 20, including without limitation, a lawyer, an accountant, a bookkeeper, and an intermediary 21 between the CEFI 20 and the CE 10.

In some non-limiting examples, as the CEFI 20 does not know the CE policy 19 adopted by the CE 10, it may seek confirmation, from a CEA 15 of the CE 10, as a CEFIA 25. Accordingly, in some non-limiting examples, a given CEA 15 may be requested to provide approval a plurality of times, as both: a CEA 15, and a CEFIA 25.

Once the CEFIAR is approved according to the CEFI policy 29, that is, payment is authorized by the CEFI 20, in some non-limiting examples, the CEFI 20 will proceed with the transaction, including without limitation, by one of: wire transfer, automatic clearing house (ACH) electronic fund transfer, and a financial transaction through the federal clearing house 50, to transfer funds to the VFI 40, and eventually to the vendor 30.

In all of the foregoing, communication of at least one of: the CEAR 1100 to the at least one CEA 15, and the CEFIAR to the at least one CEFIA 25, may be made by any number of mechanisms, including without limitation, a handwritten signature on at least one of: the CEPR 500/CEFIPR, the CEAR 1100/CEFIAR associated therewith, an e-mail thread with the CEA 15/CEFIA 25 approving the CEAR 1100/CEFIAR, and by logging into a portal whose purpose is to effect approval of the CEAR 1100/CEFIAR in accordance with the governing CE policy 19/CEFI policy 29.

In some non-limiting examples, at least one of: a data format, and technology, employed by the CE 10 to approve the CEAR 1100 may differ from a corresponding at least one of: a data format, and technology, employed by the CEFI 20 to approve the CEFIAR. In some non-limiting examples, the CEFI 20 may provide banking services to a plurality of CEs 10, and in some non-limiting examples, at least one of: a data format, and technology, employed by a first CE 10 may differ from a corresponding at least one of: a data format, and technology, employed by a second CE 10. In some non-limiting examples, the CE 10 may employ a plurality of CEFIs 20 to handle its banking needs, and at least one of: a data format, and technology, employed by a first CEFI 20 may differ from a corresponding at least one of: a data format, and technology, employed by a second CEFI 20.

Each of these communication mechanisms is effectively a plaintext system, relying on a certain level of trust in the communication mechanism, from respectively, visual recognition and verification of the signature, trust that the actual CEA 15/CEFIA 25 read, and responded to, the e-mail thread, trust that the actual CEA 15/CEFIA 25 logged into the portal, and trust in the security of an IT back office maintaining at least one of: the e-mail system, and the portal.

If this level of trust is not valid, the validity of the payment approval process may be compromised, including without limitation, permitting alteration of at least one of: an amount, and a payee, of the CEAR 1100/CEFIAR, permitting approval of a fraudulent one of the: CEPR 500, CEAR 1100, CEFIPR, and CEFIAR.

While there are products available on the market designed to facilitate the approval process within a subscribing CE 10/CEFI 20, such products are typically limited to the subscribing CE 10/CEFI 20, and may not extend beyond that entity. In any event, such products do not address the plaintext nature of the communication mechanisms, such that the validity of the payment approval process may still be compromised.

There may be an aim to provide a system and method that cloaks the payment approval process with an encryption mechanism, irrespective of the communication mechanism employed to secure approvals from the CEA 15/CEFIA 25.

This background information is provided to reveal information believed to be of possible relevance to the present disclosure. No admission is necessarily intended, nor should it be construed, that any of the preceding information constitutes prior art against the present disclosure.

### SUMMARY

It is an aim of the present disclosure to mitigate at least one disadvantage of the prior art.

The present disclosure discloses a method and system for arranging for authorization of an item, comprising actions of: creating an item request record, comprising information related to an item; digitally signing the item request record; confirming the digital signature of the item request record; submitting an authorization request associated with the item, for authorization by at least one authorizer; securing authorization of the authorization request by the at least one authorizer; generating an authorized item request digitally signed by the at least one authorizer; and validating the digital signature of a next authorizer in the authorization item request until the digital signature(s) of all of the at least one authorizers have been validated. The system may comprise a processor and a computer-readable and executable medium for containing instructions that, when executed by the processor, cause the system to perform the actions of the method.

According to a broad aspect, there is disclosed a method of arranging for authorization of an item, comprising actions of: creating an item request record, comprising information related to an item; digitally signing the item request record; confirming the digital signature of the item request record; submitting an authorization request associated with the item, for authorization by at least one authorizer; securing authorization of the authorization request by the at least one authorizer; generating an authorized item request digitally signed by the at least one authorizer; and validating the digital signature of a next authorizer in the authorization item request until the digital signature(s) of all of the at least one authorizers have been validated.

In some non-limiting examples, the information related to the item request may comprise at least one of: information identifying an initiator, information identifying a recipient, and information identifying the item.

In some non-limiting examples, the action of creating may be performed by the initiator.

In some non-limiting examples, the item request record may be stored on a storage device.

In some non-limiting examples, the method may comprise an action of providing the item request record to the authorization software.

In some non-limiting examples, the action of providing may precede the action of confirming.

In some non-limiting examples, the action of digitally signing may comprise an action of encrypting the item request record with a cryptographic key of an initiator of the item request record.

In some non-limiting examples, the cryptographic key may be one of: a private key in an asymmetric key approach, and a symmetric key in a symmetric key approach.

In some non-limiting examples, the action of digitally signing may comprise an action of hashing the item request record.

In some non-limiting examples, the method may comprise an action of associating the digital signature of the item request record with the item request record.

In some non-limiting examples, the action of confirming may comprise an action of decrypting the digital signature of the item request payload to generate a decryption result thereof.

In some non-limiting examples, the authorization request may comprise the item request record, the digital signature thereof, and a list of the at least one authorizer(s).

In some non-limiting examples, the list may be based on a policy establishing at least one item authorization rule.

In some non-limiting examples, the action of securing may comprise an action of authorizing the authorization request by digitally signing the authorization request.

In some non-limiting examples, the action of authorizing may comprise an action of encrypting the item authorization record with a cryptographic key of the authorizer.

In some non-limiting examples, the action of approving may comprise an action of hashing the item authorization record.

According to a broad aspect, there is disclosed a secure authorization system for authorizing an item comprising a processor, and a computer readable and executable medium for containing instructions that, when executed by the processor, cause the system to perform actions of: creating an item request record, comprising information related to an item; digitally signing the item request record; confirming the digital signature of the item request record; submitting an authorization request associated with the item, for authorization by at least one authorizer; securing authorization of the authorization request by the at least one authorizer; generating an authorized item request digitally signed by the at least one authorizer; validating the digital signature of a next authorizer in the approved item request until the digital signature(s) of all of the at least one authorizers have been validated; and authorizing the item.

### BRIEF DESCRIPTION OF THE DRAWINGS

Examples of the present disclosure will now be described by reference to the following figures, in which identical reference numerals in different figures indicate at least one of: identical, and in some non-limiting examples, at least one of: analogous, and corresponding elements, and in which:

FIG. 1 is a block diagram, showing schematically, an example process for authorization of an item, according to a non-limiting example;

FIG. 2 is a non-limiting example of a public key of size 1024 bits according to a non-limiting example;

FIG. 3 is a non-limiting example of a private key of size 1024 bits according to a non-limiting example;

FIG. 4 is a flow chart showing method actions in an asymmetric key approach for authorization of an item, such as approval of a payment request made to a commercial entity, according to a non-limiting example;

FIG. 5 is a non-limiting example of a payment request payload for a commercial entity according to a non-limiting example;

FIG. 6 is a flow chart showing method actions to perform digital signature of a data record according to a non-limiting example;

FIG. 7 is a non-limiting example of a hash value corresponding to the payment request payload of FIG. 5, according to a non-limiting example;

FIG. 8 is a non-limiting example of an encrypted text string corresponding to the hash value of FIG. 7, according to a non-limiting example;

FIG. 9 is a non-limiting example of the payment request payload of FIG. 5 concatenated with the encrypted text string of FIG. 8, according to a non-limiting example;

FIG. 10 is a flow chart showing method actions to validate a digital signature of a data record according to a non-limiting example;

FIG. 11 is a non-limiting example of a payment approval request, according to a non-limiting example;

FIGS. 12A-12D are non-limiting examples, of various payment rules in authorization policy, according to a non-limiting example;

FIG. 13 is a non-limiting example of an approved payment approval request, according to a non-limiting example;

FIG. 14 is a flow chart showing method actions in an asymmetric key approach for authorization of an item, such as approval of a payment request made to a financial institution of the commercial entity, according to a non-limiting example;

FIG. 15 is a non-limiting example of a symmetric key of size 128 bits according to a non-limiting example;

FIG. 16 is a block diagram of an example electronic device within a computing and communications environment that may be used for implementing devices and methods in accordance with representative examples of the present disclosure, including without limitation, for carrying out the methods of FIGS. 4, 6, 10, and 14.

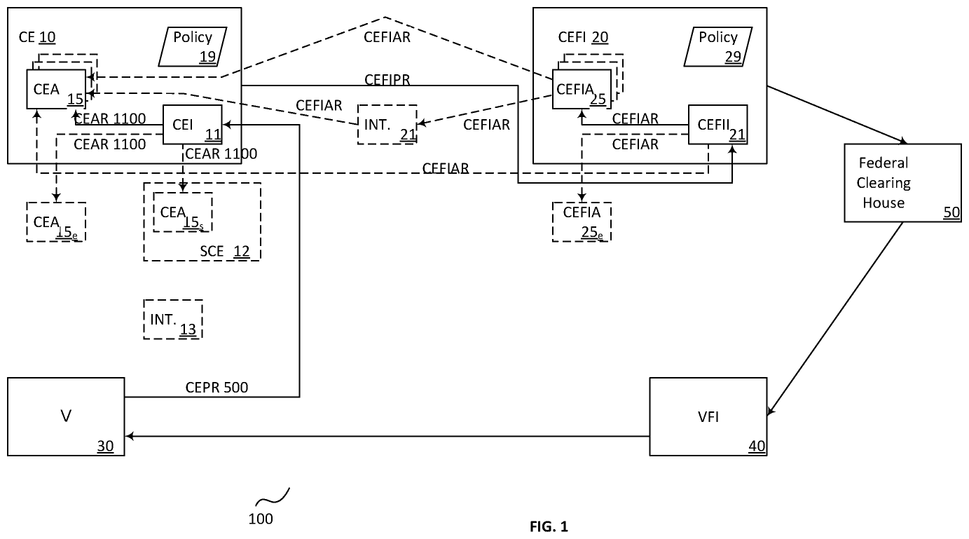

In the present disclosure, a reference numeral having at least one of: at least one numeric value (including without limitation, in at least one of: superscript, and subscript), and at least one alphabetic character (including without limitation, in lower-case) appended thereto, may be considered to refer to at least one of: a particular instance, and subset thereof, of the feature (element) described by the reference numeral. Reference to the reference numeral without reference to the at least one of: the appended value(s), and the character(s), may, as the context dictates, refer generally to the feature(s) described by at least one of: the reference numeral, and the set of all instances described thereby. Similarly, a reference numeral may have the letter “x’ in the place of a numeric digit. Reference to such reference numeral may, as the context dictates, refer generally to feature(s) described by the reference numeral, where the character “x” is replaced by at least one of: a numeric digit, and the set of all instances described thereby.

In the present disclosure, for purposes of explanation and not limitation, specific details are set forth to provide a thorough understanding of the present disclosure, including without limitation, particular architectures, interfaces and techniques. In some instances, detailed descriptions of well-known systems, technologies, components, devices, circuits, methods, and applications are omitted to not obscure the description of the present disclosure with unnecessary detail.

Further, it will be appreciated that block diagrams reproduced herein can represent conceptual views of illustrative components embodying the principles of the technology.

Accordingly, the system and method components have been represented where appropriate by conventional symbols in the drawings, showing only those specific details that are pertinent to understanding the examples of the present disclosure, to not obscure the disclosure with details that will be readily apparent to those of ordinary skill in the art having the benefit of the description herein.

Any drawings provided herein may not be drawn to scale and may not be considered to limit the present disclosure in any way.

Any feature shown in dashed outline may in some examples be considered as optional.

### DESCRIPTION

The present disclosure provides a secure payment approval system. Those having ordinary skill in the relevant art will appreciate that while the disclosure uses as an example, a payment request approval system, the present disclosure may, in some non-limiting examples, have application for secure authorization of any kind of item, and may not be solely limited to secure approval of payment requests. In some non-limiting examples, the approval may be of an item such as a legal document, or of a software release.

### Asymmetric Key Approach

In some non-limiting examples, the encryption may employ assymetric encryption, a method of encrypting data with two different keys, including without limitation, Rivest-Shamir-Adelman (RSA) encryption, and elliptic curve digital signal algorithm (ECDSA). One of the keys is made publicly available (public key) 200. The other key is not made publicly available but rather is known to only one entity (private key) 300. In public key cryptography, the public key 200 and the private key 300 are related in that data that has been encrypted in a specified manner using the public key 200 can only be decrypted using the private key 300. In some non-limiting examples, at least one of: the public key 200, and the private key 300, may have a bit length that is one of: 512, 1024, and 2048 bits.

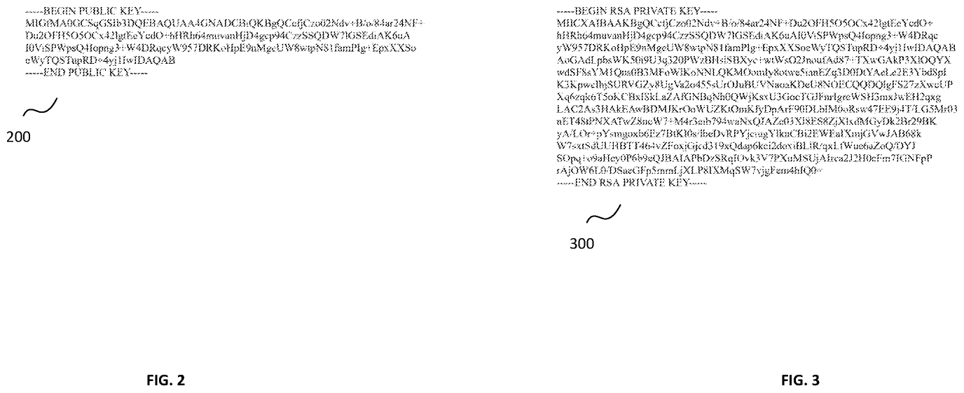

FIG. 2 is a non-limiting example of a public key 200 of size 1024 bits (corresponding to 128 characters).

FIG. 3 is a non-limiting example of a private key 300 of size 1024 bits.

In an asymmetric key approach, each person involved in the authorization of the item, including without limitation, a payment approval process, including without limitation, the at least one CEI 11/CEFII 21, and the at least one CEA 15/CEFIA 25, generates both a public key 200 and a private key 300. In some non-limiting examples, this may be accomplished by employing software that generates an asymmetric key, including without example, OpenSSL, a software library that contains an open-source implementations of basic cryptographic functions for a number of symmetric and asymmetric cryptographic algorithms for use in a variety of computer languages, and is available for many common operating systems. In some non-limiting examples, OpenSSL is pre-installed on most personal computers.

In some non-limiting examples, the software for generating the public key 200 and the private key 300 may be embedded in, and accessible as part of, the software implementing the payment approval in accordance with the corresponding CE policy 19/CEFI policy 29. A method of authorization of an item, including without limitation, payment approval in accordance with the corresponding CE policy 19 may be denoted as CE software (CES) 400. A method of authorization of an item, including without limitation, payment approval in accordance with the corresponding CEFI policy 29 may be denoted as CEFI software (CEFIS) 1400.

When used in asymmetric encryption, the software outputs both a public key 200 and a private key 300 in text form, including without limitation, saved in respective files. Each person involved in the authorization of the item, including without limitation, a payment approval process, including without limitation, at least one of: the CEI 11, CEFII 21, the at least one CEA 15, and the at least one CEFIA 25, may specify a size of the public key 200 and the private key 300. In some non-limiting examples, the larger the size of the key 200, 300, 1500, the more difficult it will be decrypt a message encrypted thereby through brute force only. In some non-limiting examples, a key 200, 300, 1500 of 512 bits may take on the order of 3 years of processing on a high end processor to decrypt, while a key 200, 300, 1500 of 1204 bits may take on the order of about 7 years of processing with the same computer to decrypt by brute force.

In some non-limiting examples, such person 11, 15, 21, 25 may specify a human-memorable password to protect, and access, the generated private key 300.

Once the public key 200 and the private key 300 are generated, the person 11, 15, 21, 25 involved in the payment approval process stores the private key 300 on a storage device associated with such person, including without limitation, in the cloud.

Additionally, the person 11, 15, 21, 25 involved in the payment approval process forwards the public key 200 to the CES 500/CEFIS 1400, which stores the public key 200 for purposes of using it to verify any authorization purportedly from such person 11, 15, 21, 25. In some non-limiting examples, the CES 400/CEFIS 1400 stores the private key 300 in encrypted form using a key known only to the CES 400/CEFIS 1400.

### At the CE

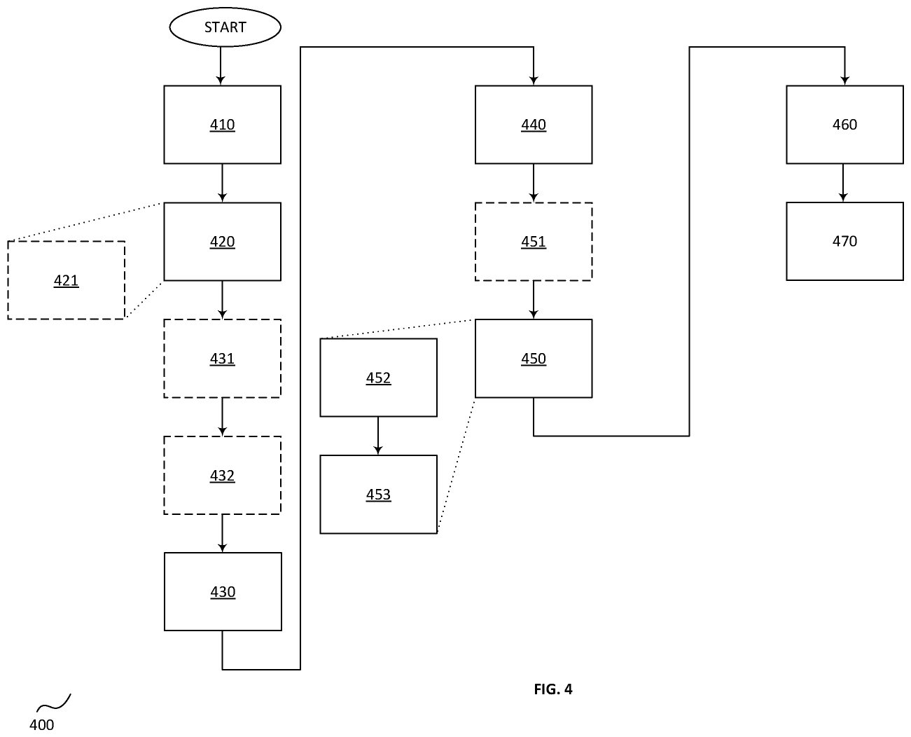

Turning now to FIG. 4, there is shown an example flow chart, shown generally at 400, showing example actions, including without limitation, as implemented by the CES 400, to arrange for secure authorization of an item, including without limitation, approval of payment of a payment request, including without limitation, a CEPR 500, according to an example in the present disclosure.

One example action 410, is for an initiator, including without limitation, the CEI 11, to create an item request record, including without limitation, a payment request record, including without limitation, a CEPR payload.

The CEPR payload comprises information related to the CEPR 500, including without limitation, information identifying the initiator, including without limitation, the payor (the CE 10), information identifying the recipient, including without limitation, the payee (the vendor 30), information about the item, including without limitation, a payment amount, and other details related to the CEPR 500. A non-limiting example of a CEPR payload is shown in FIG. 5.

In some non-limiting examples, the CEPR payload may be created by the CEI 11.

In some non-limiting examples, the CEPR payload may be created at one of: a user interface (UI), and a command line interface (CLI), of the CES 400 accessible to the CEI 11.

In some non-limiting examples, the CEPR payload may be stored on a storage device associated with the CE 10, including without limitation, in the cloud, including without limitation, the CES 400.

One example action 420 may be for the initiator to digitally sign the item request record.

In some non-limiting examples, the CEI 11 will have previously generated and stored a private key 300.

The action 420 of digitally signing the CEPR payload accepts as inputs, the CEPR payload and the private key 300 of the CEI 11.

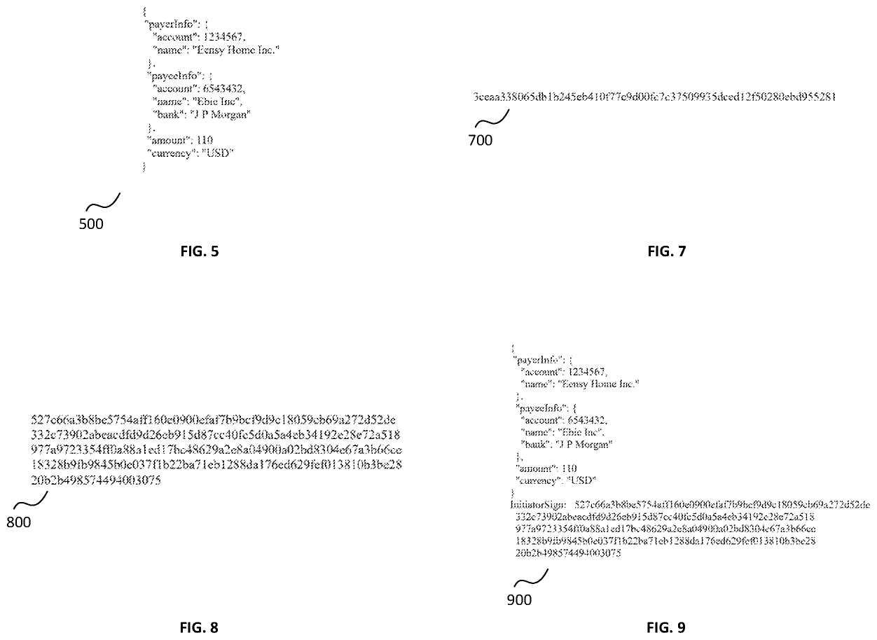

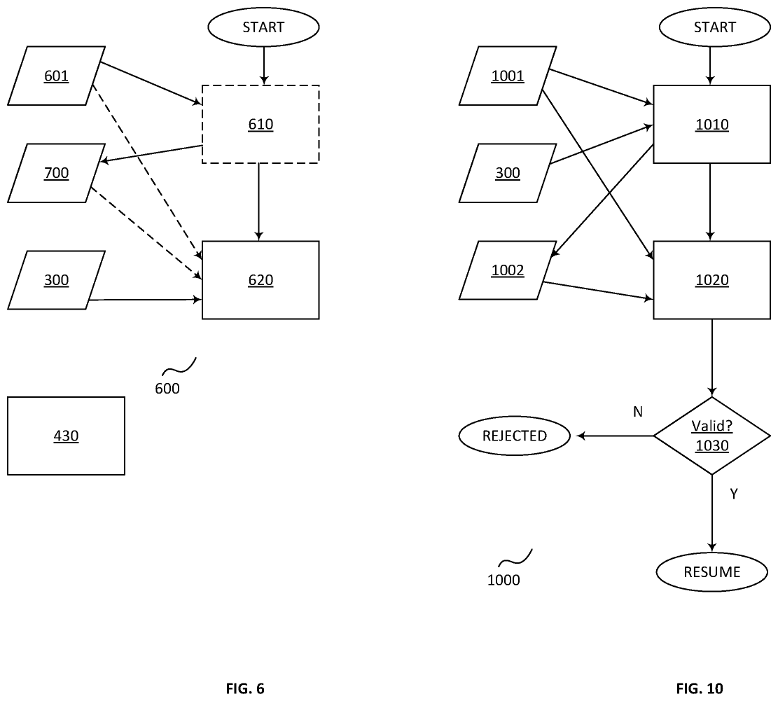

Turning now to FIG. 6, there is shown an example flow chart, showing example actions to digitally sign 600 a data record 601. In the context of action 420, the data record 601 will be the CEPR payload. In the context of action 453, the data record 601 will be the CEAR 1100. In the context of action 1420, the data record 601 will be the CEFIPR payload. In the context of action 1453, the data record 601 will be the CEFIAR.

In some non-limiting examples, an example action 610 may be to hash the data record 601. Hashing is a process of transforming a string of characters into another value, including without limitation, a fixed-length, including without limitation, shorter, string that represents the original string. Hashing may be used for a variety of purposes including data indexing and retrieval, digital signatures, cybersecurity, and cryptography.

The action of hashing 610 accepts as input, the data record 601, applies a hash function thereto, and generates a hashed value 700 thereof. FIG. 7 shows a non-limiting example of a hash value 700 resulting from hashing 610 a data record 601 comprising the CEPR payload shown in FIG. 5 using the SHA256 algorithm.

In some non-limiting examples, the hash function may be installed on a personal computer (not shown). In some non-limiting examples, the hash function may be accessible on a remote server (not shown). In some non-limiting examples, the hash function may be embedded in, and accessible as part of, the CES 400.

In some non-limiting examples, the action of hashing 610 may comprise selecting an appropriate hashing function.

In some non-limiting examples, the hash function may apply a one-way hashing algorithm to prevent the conversion of the hash value 700 back into the original string by re-application of the hashing algorithm. In some non-limiting examples, the hashing function may be one of: secure hash algorithm (SHA), including without limitation, SHA256, and the MD5 message-digest algorithm. In some non-limiting examples, a length of the hashed value 700 may depend upon the selected hash function. In some non-limiting examples, the SHA256 hash function may output hash values 700 having a bit length of 256 bits (corresponding to 32 characters).

One example action 620 is to encrypt the data record 601. The action of encrypting 620 accepts as input, the private key 300 of the digital signer, and one of: the data record 601, and if available, the hashed value 700 thereof, applies an encryption function to one of: the data record 601, and if available, the hashed value 700 thereof, and generates a digital signature, including without limitation, an encrypted text string 800. FIG. 8 shows a non-limiting example of an digital signature 800 resulting from encrypting the hash value 700 shown in FIG. 7.

In some non-limiting examples, the encryption function may be installed on a personal computer (not shown). In some non-limiting examples, the encryption function may be accessible on a remote server (not shown). In some non-limiting examples, the encryption function may be embedded in, and accessible as part of, the CES 400.

In some non-limiting examples, the action of encrypting 620 may comprise selecting an appropriate encryption function.

In some non-limiting examples, a length of the digital signature 800 may depend on a size of the private key 300, the selected encryption function, and if employed, the length of the hashed value 700. In some non-limiting examples, the RSA algorithm, employed with a private key 300 having a bit length of 128 bits on one of: a data record 601, and a hashed value 700 thereof, having a bit length of 256 bits, may output digital signature 800 of 1024 bits (corresponding to 128 characters).

Those having ordinary skill in the relevant art will appreciate that, in some non-limiting examples, the actions of creating the CEPR payload and the action of digitally signing 420 the CEPR payload may be performed by the CES 400. In such scenario, both the CEPR payload and the digital signature 800 may be accessible at the CES 400.

In some non-limiting examples, the action 410 of creating the CEPR payload may not be performed by the CES 400, but may be performed by alternative means, including without limitation, completing one of: a software form, and a hard copy form of the CEPR payload. In such scenario, in some non-limiting examples, an example action may be to provide 431 the CEPR payload to the CES 400 to be associated with the digital signature 800_{CEI} corresponding to the CEPR payload digitally signed by the CEI 11. In some non-limiting examples, the action of providing 431 the CEPR payload may be performed by the CEI 11 by one of: scanning, uploading, attaching, sending, and entering, the CEPR payload at one of: a UI, and a CLI, of the CES 400 accessible to the CEI 11.

In some non-limiting examples, the action of digital signing 420 may not be performed by the CES 400. In such scenario, in some non-limiting examples, an example action may be to associate 432 the digital signature 800_{CEI} corresponding to the CEPR payload digitally signed by the CEI 11, with the CEPR payload at the CES 400. In some non-limiting examples, the action of associating 432 the digital signature 800 may be performed by the CEI 11 by one of: scanning, uploading, attaching, sending, and entering, the encrypted text string 800 at one of: a UI, and a CLI, of the CES 400 accessible to the CEI 11.

However provided to the CES 400, the CEPR payload and the encrypted text string 800_{CEI} corresponding to the CEPR payload digitally signed by the CEI 11, are available at the CES 400 prior to action 430.

In some non-limiting examples, the CEPR payload may be concatenated with the digital signature 800_{CEI} corresponding to the CEPR payload digitally signed by the CEI 11.

FIG. 9 shows a non-limiting example 900 of the CEPR payload of FIG. 5 with the digital signature 800_{CEI} corresponding to the CEPR payload digitally signed by the CEI 11 of FIG. 8.

One example action 430 may be to validate 1000 the initiator's digital signature. The action 430 accepts as inputs, the CEPR payload and the public key 200 of the initiator.

Turning now to FIG. 10, there is shown an example flow chart, showing example actions to validate 1000 a digital signature of a data record 1001. In the context of action 430, the data record 1001 will be the CEPR payload. In the context of action 470, the data record 1001 will be the CEAR 1100.

One example action 1010 is to decrypt the data record 1001. The action of decrypting 1010 accepts as input, the public key 200 of the digital signer, and the data record 1001, applies a decryption function to the data record 1001 using the public key 200, to generate a decryption result 1002, including without limitation, a text string.

In some non-limiting examples, the decryption function may be installed on a personal computer (not shown). In some non-limiting examples, the decryption function may be accessible on a remote server (not shown). In some non-limiting examples, the decryption function may be embedded in, and accessible as part of, the CES 400.

In some non-limiting examples, the action of decrypting 1010 may comprise selecting an appropriate decryption function. In some non-limiting examples, the decryption function may be compatible with the encryption function employed in the action of encrypting 620.

One example action 1020 is to compare the data record 1001 and the decryption result 1002 and return 1030 a comparison result.

If the decryption result 1002 is identical to the data record 1001, then the action of validating 1000 is successful. If, however, the decrypted text string 1002 is not identical to the data record 1001, then the action of validating 1000 is not successful and the data record 1001 is rejected.

If the action of validating 430 is successful, processing continues at action 440. If the action of validating 430 is not successful, the CEPR payload is rejected. In some non-limiting examples, processing may resume at action 410.

One example action 440 may be to submit an authorization request, including without limitation, a CEAR 1100 associated with the item, including without limitation, the CEPR 500, for authorization, including without limitation, approval by at least one authorizer, including without limitation, an approver, including without limitation, at least one CEA 15.

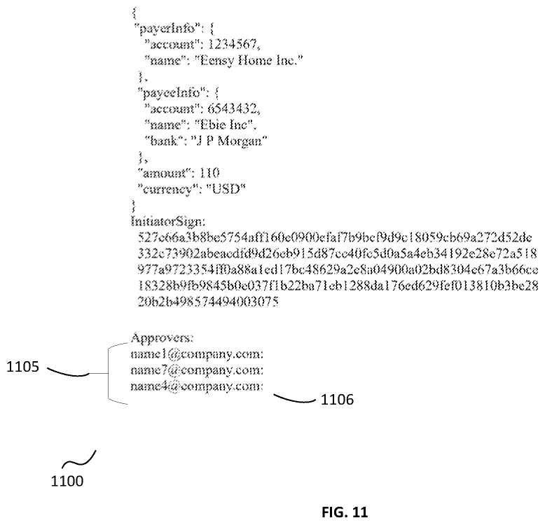

In some non-limiting examples, the CEAR 1100 comprises the CEPR payload, a digital signature 800_{CEI} corresponding to the CEPR payload digitally signed by the CEI 11, and a list 1105 of at least one CEA 15 identified as an approver. FIG. 11 shows a non-limiting example of a CEAR 1100.

In some non-limiting examples, the list 1105 of at least one CEA 15 may be generated by the CES 400 based on a CE policy 19 accessible to the CES 400. In some non-limiting examples, the list 1105 identifies the listed at least one CEA 15 by an unambiguous identifier 1106, including without limitation, at least one of: a name, an e-mail address, a phone number, and an identifier of the CEA 15.

The CE policy 19 establishes at least one item authorization rule, including without limitation, a payment approval rule 1210, 1220, 1230, 1240 for the CEPR 500, including without limitation, an unordered rule 1210, a sequentially ordered rule 1220, a parallel ordered rule 1230, and a hybrid ordered rule 1240. Each payment rule 1210, 1220, 1230, 1240 identifies a corresponding list 1105 of at least one CEA 15.

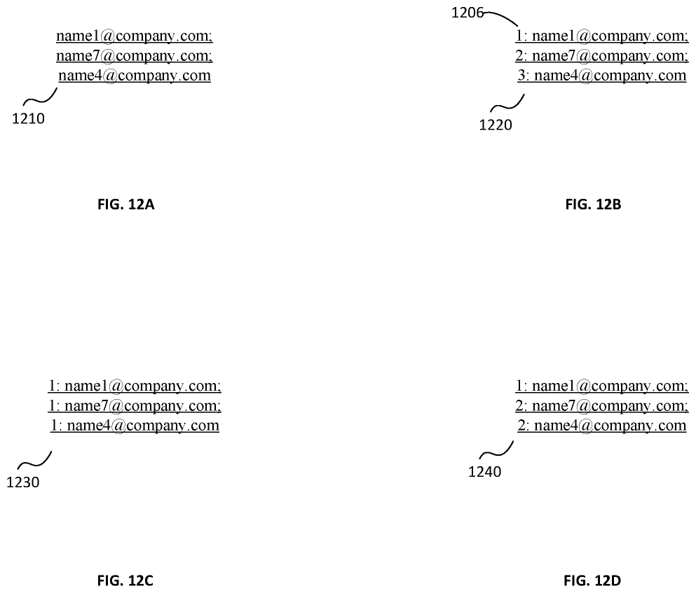

In some non-limiting examples, an unordered rule 1210 provides that each of the listed CEAs 15 on the list 1105 are to approve the CEAR 1100. However, in the unordered rule 1210, the listed CEA(s) 15 may approve the CEAR 1100 in any order. In some non-limiting examples, the list 1105 may identify an unordered rule 1210 by listing each of the CEA(s) 15 without a numerical prefix before it. A non-limiting example of a list 1105 specifying an unordered rule 1210 is shown in FIG. 12A.

In some non-limiting examples, a sequentially ordered rule 1220 provides that each of the listed CEAs 15 on the list 1105 are to approve the CEAR 1100, but in an order specified in the list 1105. In some non-limiting examples, the list 1105 may identify a sequentially ordered rule 1220 by preceding each of the listed CEA(s) 15 with a numerical prefix 1206, whose ordinal value specifies the sequence. A non-limiting example of a list 1105 specifying a sequentially ordered rule 1220 is shown in FIG. 12B, where the numerical prefix 1206 is separated from the identifier 1106 by a colon. In the example shown in FIG. 12B, the CEA 15 whose identifier 1106 is preceded by a numerical prefix 1206 of 2 is to approve the CEAR 1100 before the CEA 15 whose identifier 1106 is preceded by a numerical prefix 1206 of 3, but after the CEA 15 whose identifier 1106 is preceded by a numerical prefix 1206 of 1. In some non-limiting examples, the numerical prefix 1206 may correspond to a level in an approval hierarchy.

In some non-limiting examples, a parallel ordered rule 1230 provides that any one, but only one, of the listed CEAs 15 on the list 1105 are to approve the CEAR 1100. In some non-limiting examples, the list 1105 may identify a parallel ordered rule 1230 by preceding each of the CEA(s) 15 with a numerical prefix 1206 having a common ordinal value. A non-limiting example of a list 1105 specifying a parallel ordered rule 1230 is shown in FIG. 12C. In the example shown in FIG. 12C, the CEAs 15 in the list 1105 all bear the numerical prefix 1206 of 1.

In some non-limiting examples, a hybrid ordered rule 1240 provides a sequential order of listed CEA(s) 15 for approving the CEAR 1100, but specifies that for a plurality of CEA(s) 15 in the list 1105, any one, but only one of the plurality are to approve the CEAR 1100. In some non-limiting examples, the list 1105 may identify a hybrid ordered rule 1250 by preceding each of the CEA(s) 15 with a numerical prefix 1206 having an ordinal value, where the plurality of CEA(s) 15 have the same numerical prefix 1206. A non-limiting example of a list 1105 specifying a sequential and parallel ordered rule 1240 is shown in FIG. 12D. In the example shown in FIG. 12D, any one, but only one, of the CEAs 15 in the list 1105 bearing the numerical prefix 1206 of 2 are to approve the CEAR 1100 but after the CEA 15 bearing the numerical prefix 1206 of 1.

One example action 450 is to secure authorization, including without limitation, approval of the item, including without limitation, the CEAR 1100 from each of the at least one authorizers, including without limitation, the approver(s), including without limitation, each of the at least one CEA(s) 15 identified in the list 1105. In some non-limiting examples, action 450 may comprise actions 452 and 453.

In some non-limiting examples, the action of securing authorization 450 of the CEAR 1100 may be performed by the CES 400.

In some non-limiting examples, the action of securing authorization of the CEAR 1100 may not be performed by the CES 400. In such scenario, an example action may be to forward 451 the CEAR 1100 to the CEI 11. In some non-limiting examples, the action 451 may precede action 450.

Whether performed by the CEI 11 or the CES 400, one example action 452 is to forward the CEAR 1100 to the next at least one CEA 15 identified in the list 1105 scheduled to authorize the CEAR 1100.

In the case of one of: a sequential ordered rule 1220, and a sequential and parallel ordered rule 1240, this will be the at least one CEA 15 having a numerical prefix 1206 having a lowest ordinal value that has not already authorized the CEAR 1100. Once such authorization has been received, processing returns to action 452 if appropriate.

In the case of one of: a non-ordered rule 1210, and a parallel ordered rule 1230, this will be each of the CEA(s) 15 in the list 1105.

If the action 452 is to be performed by the CEI 11, the CEI 11 may use the identifier 1106 of the at least one CEA(s) 15 to appropriately communicate with the CEA 15. In some non-limiting examples, if the identifier 1106 comprises an e-mail address, the CEI 11 may send the CEAR 1100 to the CEA 15 by e-mail. In some non-limiting examples, if the identifier 1106 is a phone number, the CEI 11 may one of: text the CEAR 1100 to the CEA 15, and call the CEA 15 to arrange for the CEA 15 to authorize the CEAR 1100. In some non-limiting examples, if the identifier 1106 is a number, the CEI 11 may use the name to identify an appropriate method of communicating with the CEA 15 to arrange for the CEA 15 to authorize the CEAR 1100, including without limitation, one of: bringing the CEAR 1100 to the CEA 15, and asking the CEA 15 to come to the CEI 11 to get the CEAR 1100.

One example action 453 is to authorize the CEAR 1100. The action 453 will be performed by the at least one CEA 15 to whom the CEAR 1100 has been forwarded in action 452. In the action of authorizing 453, the CEA 15 digitally signs 600 a data record 601 comprising the CEAR 1100 and returns the digitally signed CEAR 1100 to its sender, including without limitation, the CES 400, and the CEI 11.

Once the item authorization rule has been satisfied by the receipt of the requisite authorizations, the action of securing authorization 450 has been completed and processing continues.

One example action 460 is generate an authorized item request, including without limitation, an approved payment request (ACEAR) 1300 digitally signed by the at least one authorizer.

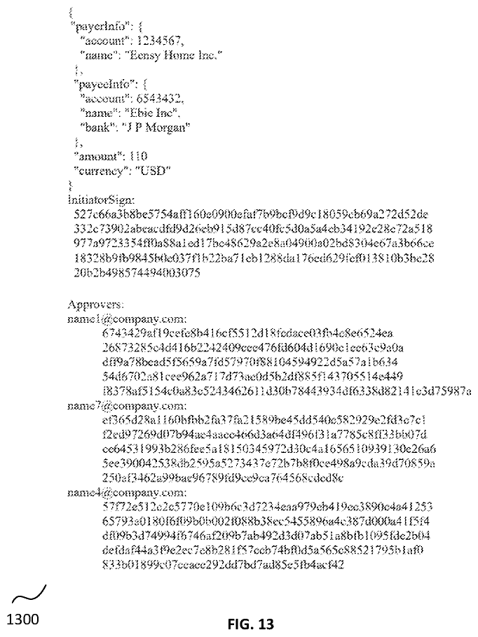

In some non-limiting examples, the ACEAR 1300 comprises the CEPR payload, a digital signature 800_{CEI} corresponding to the CEPR payload digitally signed by the CEI 11, a list 1105 of at least one CEA 15 identified as an authorizer, and for each authorizer in the list, a digital signature 800_{CEA} corresponding to the CEAR 1100 digitally signed by such authorizer. FIG. 13 shows a non-limiting example of an ACEAR 1300.

One example action 470 is to validate the digital signature of the next authorizer identified in the ACEAR 1300 until the digital signature(s) of all of the at least one authorizers have been validated. In some non-limiting examples, each action of validating 470 is performed by the CES 400 in accordance with action 1000.

The action 470 accepts as input, the digital signature 800_{CEA} and the public key 200 of the CEA 15.

If the action of validating 470 is successful, processing continues at action 480. If the action of validating 470 is not successful, the ACEAR 1300, including without limitation, the invalid digital signature of the CEA 15, is rejected. In some non-limiting examples, processing may resume at action 452 to secure a valid signature of such CEA 15.

Once all of the digital signatures of the at least one CEA(s) 15 identified in the ACEAR 1300 have been validated, processing continues.

In some non-limiting examples, such processing may comprise an action (not shown) of remitting payment for the CEPR 500.

In some non-limiting examples, the action of remitting payment of the CEPR 500 may be performed by the CES 400.

In some non-limiting examples, the action of remitting payment may not be performed by the CES 400. In such scenario, the CES 400 forwards the ACEAR 1300 to the CEI 11.

Whether performed by the CES 400 or the CEI 11, in some non-limiting examples, one example action (not shown) is to forward a CEFIPR to the CEFI 20.

### At the CEFI

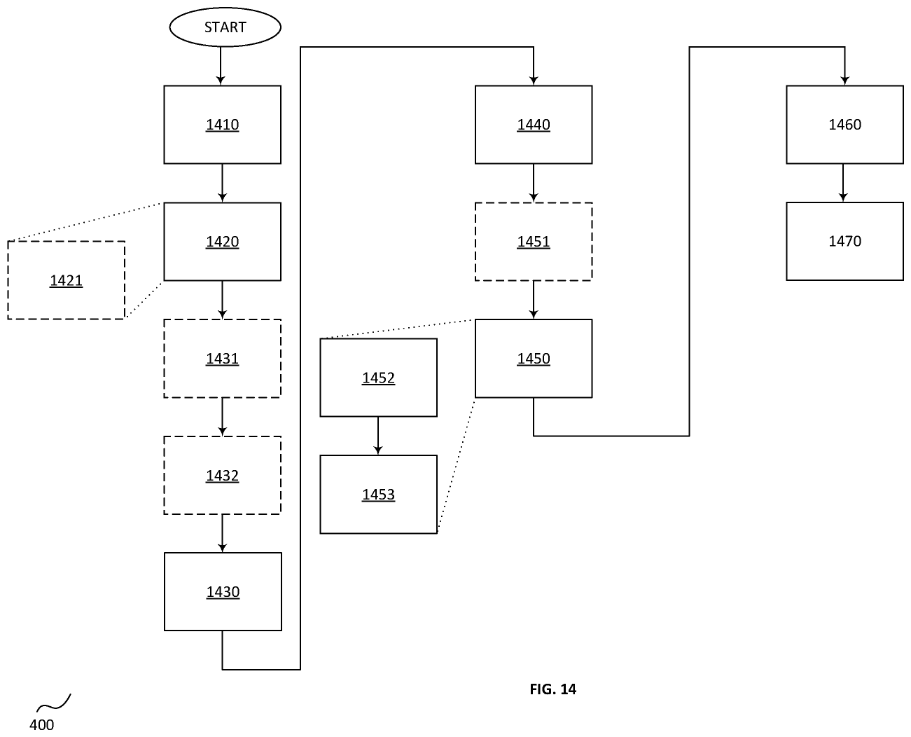

Turning now to FIG. 14, there is shown an example flow chart, shown generally at 1400, showing example actions, including without limitation, as implemented by the CEFIS 1400, to arrange for secure authorization of an item, including without limitation, approval of a payment request, including without limitation, a CEFIPR, according to an example in the present disclosure.

One example action 1410, is for an initiator, including without limitation the CEFII 21, to create an item request record, including without limitation, a payment request record, including without limitation, a CEFIPR payload.

The CEFIPR payload comprises information related to the CEFIPR, including without limitation, information identifying the initiator, including without limitation, the payor (the CEFI 20), information identifying the recipient, including without limitation, the payee (the vendor 30), information about the item, including without limitation, a payment amount, and other details related to the CEFIPR. In some non-limiting examples, the CEFIPR payload may be similar to the CEPR payload shown in FIG. 5.

In some non-limiting examples, the CEFIPR payload may be created by the CEFII 21.

In some non-limiting examples, the CEFIPR payload may be created at one of: a user interface (UI), and a command line interface (CLI), of the CEFIS 1400 accessible to the CEFII 21.

In some non-limiting examples, the CEFIPR payload may be stored on a storage device associated with the CEFIPR, including without limitation, in the cloud, including without limitation, the CEFIS 1400.

One example action 1420 may be for the initiator to digitally sign the item request record.

In some non-limiting examples, the CEFII 21 will have previously generated and stored a private key 300.

The action 1420 of digitally signing the CEFIPR payload accepts as inputs, the CEFIPR payload and the private key 300 of the CEFII 21.

Those having ordinary skill in the relevant art will appreciate that, in some non-limiting examples, the actions of creating the CEFIPR payload and the action of digitally signing 1420 the CEFIPR payload may be performed by the CEFIS 1400. In such scenario, both the CEFIPR payload and the encrypted text string 800 are accessible at the CEFIS 1400.

In some non-limiting examples, the action 410 of creating the CEFIPR payload may not be performed by the CEFIS 1400, but may be performed by alternative means, including without limitation, completing one of: a software form, and a hard copy form of the CEFIPR payload. In such scenario, in some non-limiting examples, an example action may be to provide 1431 the CEFIPR payload to the CES 400 to be associated with the encrypted text string 800_{CEFII} corresponding to the CEFIPR payload digitally signed by the CEFII 21. In some non-limiting examples, the action of providing 1431 the CEFIPR payload may be performed by the CEFII 21 by one of: scanning, uploading, attaching, sending, and entering, the CEFIPR payload at one of: a UI, and a CLI, of the CEFIS 1400 accessible to the CEFII 21.

In some non-limiting examples, the action of digital signing 420 may not be performed by the CEFIS 1400. In such scenario, in some non-limiting examples, an example action may be to provide 1432 the encrypted text string 800_{CEFII} corresponding to the CEFIPR payload digitally signed by the CEFII 21, to the CEFIS 1400 to be associated with the CEFIPR payload. In some non-limiting examples, the action of providing 1432 the encrypted text string 800 may be performed by the CEFII 21 by one of: scanning, uploading, attaching, sending, and entering, the encrypted text string 800 at one of: a UI, and a CLI, of the CEFIS 1400 accessible to the CEFII 21.

However provided to the CEFIS 1400, the CEFIPR payload and the encrypted text string 800_{CEFII} corresponding to the CEFIPR payload digitally signed by the CEFII 21, are stored at the CEFIS 1400 prior to action 1430.

In some non-limiting examples, the CEFIPR payload may be concatenated with the encrypted text string 800_{CEFII} corresponding to the CEFIPR payload digitally signed by the CEFII 21.

One example action 1430 may be to validate 1000 the initiator's digital signature. The action of validating 1430 accepts as inputs the CEFIPR payload and the public key 200 of the CEFII 21.

If the action of validating 1430 is successful, processing continues at action 1440. If the action of validating 1430 is not successful, the CEFIPR payload is rejected. In some non-limiting examples, processing may resume at action 1410.

One example action 1440 may be to submit an authorization request, including without limitation, a CEFIAR associated with the item, including without limitation, the CEFIPR, for authorization, including without limitation, approval by at leas tone authorizer, including without limitation, an approver, including without limitation at least one CEFIA 25.

In some non-limiting examples, the CEFIAR comprises the CEFIPR payload, an encrypted text string 800_{CEFII} corresponding to the CEFIPR payload digitally signed by the CEFII 21, and a list 1115 of at least one CEFIA 25 identified as appropriate for approving the CEFIAR 1000. In some non-limiting examples, the CEFIAR may be similar to the CEAR 1100 of FIG. 11.

In some non-limiting examples, the list 1105 of at least one CEFIA 25 may be generated by the CEFIS 1400 based on a CEFI policy 29 accessible to the CEFIS 1400. In some non-limiting examples, the list 1105 identifies the listed at least one CEFIA 25 by an unambiguous identifier 1106, including without limitation, at least one of: a name, an e-mail address, a phone number, and an identifier of the CEFIA 25.

The CEFI policy 29 establishes at least one item authorization rule, including without limitation, a payment approval rule 1210, 1220, 1230, 1240 for the CEFIPR.

One example action 1450 is to secure authorization, including without limitation, approval of the item, including without limitation, the CEFIAR from each of the at least one authorizer(s), including without limitation, the approver(s), including without limitation, each of the at least one CEFIA(s) 25 identified in the list 1105. In some non-limiting examples, action 1450 may comprise actions 1452 and 1453.

In some non-limiting examples, the action of securing approval 450 of the CEFIAR may be performed by the CEFIS 1400.

In some non-limiting examples, the action of securing authorization of the CEFIAR may not be performed by the CEFIS 1400. In such scenario, an example action may be to forward 1451 the CEFIAR to the CEFII 21. In some non-limiting examples, the action 1451 may precede action 1450.

Whether performed by the CEFIS 1400 or the CEFII 21, one example action 1452 is to forward the CEFIAR to the next at least one CEFIA 25 identified in the list 1105 scheduled to authorize the CEFIAR.

In the case of one of: a sequential ordered rule 1220, and a sequential and parallel ordered rule 1240, this will be the at least one CEFIA 25 having a numerical prefix 1206 having a lowest ordinal value that has not already authorized the CEFIAR. Once such authorization has been received, processing returns to action 1452 if appropriate.

In the case of one of: a non-ordered rule 1210, and a parallel ordered rule 1230, this will be each of the CEFIA(s) 25 in the list 1105.

If the action 1452 is to be performed by the CEFII 21, the CEFII 21 may use the identifier 1106 of the at least one CEFIA(s) 25 to appropriately communicate with the CEFIA 25. In some non-limiting examples, if the identifier 1106 comprises an e-mail address, the CEFII 21 may send the CEFIAR to the CEFIA 25 by e-mail. In some non-limiting examples, if the identifier 1106 is a phone number, the CEFII 21 may one of: text the CEFIAR to the CEFIA 25, and call the CEFIA 25 to arrange for the CEFIA 25 to authorize the CEFIAR. In some non-limiting examples, if the identifier 1106 is a number, the CEFII 21 may use the name to identify an appropriate method of communicating with the CEFIA 25 to arrange for the CEFIA 25 to authorize the CEFIAR, including without limitation, one of: bringing the CEFIAR to the CEFIA 25, and asking the CEFIA 25 to come to the CEFII 21 to get the CEFIAR.

One example action 1453 is to authorize the CEFIAR. The action 1453 will be performed by the at least one CEFIA 25 to whom the CEFIAR has been forwarded in action 1452. In the action of authorizing 1453, the CEFIA 25 digitally signs 600 a data record 601 comprising the CEFIAR and returns the digitally signed CEFIAR to its sender, including without limitation, the CEFIS 1400, and the CEFII 21.

Once the item authorization rule has been satisfied by the receipt of the requisite authorizations, the action of securing authorization 1450 has been completed and processing continues.

One example action 1460 is generate an authorized item request, including without limitation, an approved payment request (ACEFIAR) digitally signed by the at least one authorizer.

In some non-limiting examples, the ACEFIAR comprises the CEFIPR payload, a digital signature 800_{CEFI} corresponding to the CEFIPR payload digitally signed by the CEFII 21, a list 1105 of at least one CEFIA 25 identified as an authorizer, and for each authorizer in the list, a digital signature 800_{CEFIA} corresponding to the CEFIAR digitally signed by such authorizer. In some non-limiting examples, the ACEFIAR may be similar to the ACEAR 1300 of FIG. 13.

One example action 1470 is to validate the digital signature of the next authorizer identified in the ACEFIAR until the digital signature(s) of all of the at least one authorizers have been validated. . . . In some non-limiting examples, each action of validating 1470 is performed by the CEFIS 1400 in accordance with action 1000.

If the action of validating 1470 is successful, processing continues at action 1480 if appropriate. If the action of validating 470 is not successful, the ACEFIAR, including without limitation, the invalid digital signature of the CEFIA 25, is rejected. In some non-limiting examples, processing may resume at action 1452 to secure a valid signature of such CEFIA 25.

Once all of the digital signatures of the at least one CEFIA(s) 25 identified in the ACEFIAR have been validated, processing continues.

In some non-limiting examples, such processing may comprise an action (not shown) of remitting payment for the CEFIPR, including without limitation, by one of: wire transfer, ACH electronic fund transfer, and a financial transaction through the federal clearing house 50, to transfer funds to the VFI 40, and eventually to the vendor 30.

In some non-limiting examples, the action of remitting payment of the CEFIPR may be performed by the CEFIS 1400.

In some non-limiting examples, the action of remitting payment may not be performed by the CEFIS 1400. In such scenario, the CEFIS 1400 forwards the ACEFIAR to the CEFII 21.

### Symmetric Key Approach

In some non-limiting examples, the encryption may employ symmetric encryption, in which data is encrypted and decrypted using a common symmetric key 1500, including without limitation, the Advanced Encryption Standard (AES), and data encryption standard (DES). In some non-limiting examples, the key may have a bit length that is one of: 128, and 256 bits.

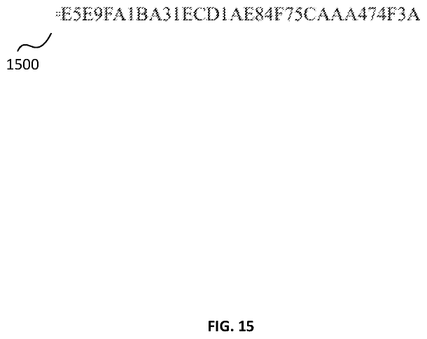

FIG. 15 is a non-limiting example of a symmetric key 1500 of size 256 bits (corresponding to 32 characters).

In a symmetric key approach, each person involved in the payment approval process, including without limitation, the at least one CEA 15/CEFIA 25, generates and stores a symmetric key 1500.

In some non-limiting examples, this may be accomplished by employing software that generates a symmetric key 1500, including without example, OpenSSL, a software library that contains an open-source implementations of basic cryptographic functions for a number of symmetric and asymmetric cryptographic algorithms for use in a variety of computer languages, and is available for many common operating systems. In some non-limiting examples, OpenSSL is pre-installed on most personal computers.

When used to generate a symmetric key, the CES 400/CEFIS 1400 outputs a single symmetric key 1500 in text form, including without limitation, saved in a file. Each person involved in the payment approval process, including without limitation, at least one of: the CEI 11, CEFII 21, the at least one CEA 15, and the at least one CEFIA 25, may specify a size of the symmetric key 1500. In some non-limiting examples, such person 11, 15, 21, 25 may specify a human-memorable password to protect, and access, the generated symmetric key 1500.

Once the symmetric key 1500 is generated, the person 11, 15, 21, 25 involved in the item authorization process stores the symmetric key 1500 on a storage device associated with such person, including without limitation, in the cloud.

Additionally, the person 11, 15, 21, 25 involved in the item authorization process forwards the symmetric key 1500 to the CES 400/CEFIS 1400, which stores the symmetric key 1500 for purposes of using it to verify any authorization purportedly from such person 11, 15, 21, 25. In some non-limiting examples, the CES 400/CEFIS 1400 stores the symmetric key 1500 in encrypted form using a key known only to the CES 400/CEFIS 1400.

Processing generally follows the methods of FIGS. 4, 6, 10, and 14 described herein.

However, in action 420, the CEI 11 will have previously generated and stored the symmetric key 1500. The action 420 of digitally signing the CEPR payload accepts as inputs, the CEPR payload and the symmetric key 1500 of the CEI 11.

Further, the action of encrypting 620 accepts as input, the symmetric key 1500 of the digital signer, and one of: the data record 601, and if available, the hashed value 700 thereof, applies an encryption function to one of: the data record 601, and if available, the hashed value 700 thereof, and generates an encrypted text string 800.

Further, the action 430 accepts as inputs, the CEPR payload and the symmetric key 1500 of the CEI 11.

Further, the action of decrypting 1010 accepts as input, the symmetric key 1500 of the digital signer, and the data record 1001, applies a decryption function to the data record 1001 using the symmetric key 1500, and generates a decrypted text string 1002.

Further, in action 1420, the CEFI 21 will have previously generated and stored the symmetric key 1500. The action 1420 of digitally signing the CEFIPR payload accepts as inputs, the CEFIPR payload and the symmetric key 1500 of the CEFII 21.

Further, the action 1430 accepts as inputs, the CEFIPR payload and the symmetric key 1500 of the CEFII 21.

### Apparatus for Performing Method Actions

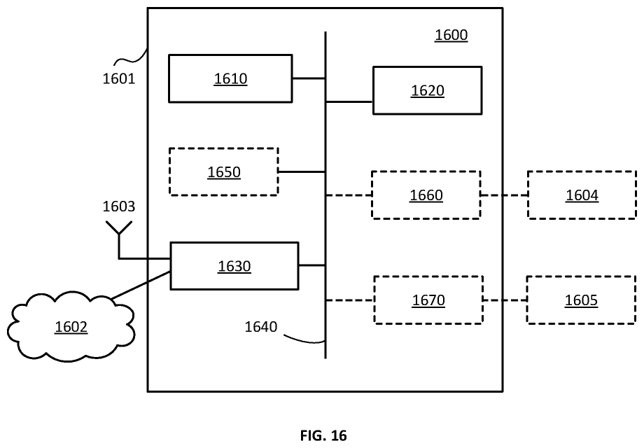

FIG. 16 is a simplified block diagram of an electronic device 1600 illustrated within a computing and communications environment 1601 that may be used for implementing the devices and methods disclosed herein.

In some non-limiting examples, the device 1600 may comprise a processor 1610, a memory 1620, a network interface 1630, and a bus 1640. In some non-limiting examples, the device 1600 may comprise a storage unit 1650, a video adapter 1660, and peripheral interface 1670.

In some non-limiting examples, specific devices 1600 may utilize one of: all of the components shown, and only a subset thereof, and levels of integration may vary from device to device.

In some non-limiting examples, a device 1600 may comprise a plurality of instances of a component.

The processor 1610 may comprise a central processing unit (CPU), which, in some non-limiting examples, may be one of: a single core processor, a multiple core processor, and a plurality of processors for parallel processing, and in some non-limiting examples, may comprise at least one of: a general-purpose, a dedicated application-specific specialized processor, including without limitation, a multiprocessor, a microcontroller, a reduced instruction set computer (RISC), a digital signal processor (DSP), a graphics processing unit (GPU), and the like, and a shared-purpose processor. In some non-limiting examples, the processor 1610 may comprise at least one of: dedicated hardware, and hardware capable of executing software. In some non-limiting examples, the processor 1610 may be part of a circuit, including without limitation, an integrated circuit. In some non-limiting examples, at least one other component of the device 1600 may be embodied in the circuit. In some non-limiting examples, the circuit may be one of: an application-specific integrated circuit (ASIC), and a floating-point gate array (FPGA).

The processor 1610 controls the general operation of the device 1600, in some non-limiting examples, by sending one of: data, and control signals, to at least one of: the memory 1620, the network interface 1630, the storage unit 1650, the video adapter 1660, and the peripheral interface 1670, and by retrieving at least one of: data, and instructions, from at least one of: the memory 1620, and the storage unit 1650, to execute methods disclosed herein. Such instructions may be executed in at least one of: simultaneous, serial, and distributed fashion, by at least one processor 1610.

In some non-limiting examples, the processor 1610 may execute a sequence of one of: machine-readable, and machine-executable, instructions, which may be embodied in one of: a program, and software. In some non-limiting examples, the program may be stored in one of: the memory 1620, and the storage unit 1650. In some non-limiting examples, the program may be retrieved from one of: the memory 1620, and the storage unit 1650, and stored in the memory 1620 for ready access, and execution, by the processor 1610. The program may be directed to the processor 1610, which may subsequently configure the processor 1610 to implement methods of the present disclosure. Non-limiting examples, of operations performed by the processor 1610 include at least one of: fetch, decode, execute, and writeback.

In some non-limiting examples, the program may be one of: pre-compiled, and configured for use with a machine having a processor adapted to execute the instructions and may be compiled during run-time. In some non-limiting examples, the program may be supplied in a programming language that may be selected to enable the instructions to execute in one of: a pre-compiled, interpreted, and an as-compiled, fashion.

However configured, the hardware of the processor 1610 may be configured so as to be capable of operating with sufficient software, processing power, memory resources, and network throughput capability, to handle any workload placed upon it.

The memory 1620 is a storage device configured to store data, programs, in the form of one of: machine-readable, and machine-executable, instructions, and other information accessible within the device 1600, along the bus 1640.

The memory 1620 may comprise any type of transitory and non-transitory memory, including without limitation, at least one of: persistent, non-persistent, and volatile storage, including without limitation, system memory, readable by the processor 1610, including without limitation, semiconductor memory devices, including without limitation, random access memory (RAM), static RAM (SRAM), dynamic RAM (DRAM), synchronous DRAM (SDRAM), read-only memory (ROM), programmable ROM (PROM), erasable PROM (EPROM), and electrically erasable PROM (EEPROM), and at least one buffer circuit including without limitation, at least one of: latches and flip flops. In some non-limiting examples, the memory 1620 may comprise a plurality of types of memory, including without limitation, ROM for use at boot-up, and DRAM for program and data storage for use while executing programs.

The network interface 1630 allows the device 1600 to communicate with remote entities, across at least one of: a telecommunications network, and a data network (network) 1602, including without limitation, the Internet, an intranet, including without limitation, one in communication with the Internet, and an extranet, including without limitation, one in communication with the Internet, and may comprise at least one of: a network adapter, a wired network interface, including without limitation, a local area network (LAN) card, including without limitation, an ethernet card, a token ring card, and a fiber distributed data interface (FDDI) card, and a wireless network interface, including without limitation, a WIFI network interface, a modem, a modem bank, a wireless local area network (LAN) card, and a radio access network (RAN) interface, including without limitation, a radio transceiver card, to connect to other devices over a radio link 1603.

In some non-limiting examples, the network 1602 may comprise at least one computer server, which may, in some non-limiting examples, comprise a device 1600, and which, in some non-limiting examples, may enable distributed computing, including without limitation, cloud computing. In some non-limiting examples, the network 1602, with the aid of the device 1600, may implement a peer-to-peer network, which may enable devices 1600 coupled with the device 1600, to behave as one of: a client, and a server.

In some non-limiting examples, the device 1600 may be a stand-alone device, while in some non-limiting examples, the device 1600 may be resident within a data centre. A data centre, as will be apparent to those having ordinary skill in the relevant art, is a collection of computing resources (typically in the form of services) that can be used as a collective computing and storage resource. Within a data centre, a plurality of services may be coupled together to provide a computing resource pool upon which virtualized entities may be instantiated. Data centres may be coupled with each other to form networks consisting of pooled computing and storage resources coupled with each other by connectivity resources. The connectivity resources may take the form of physical connections such as Ethernet and optical communications links, and in some instances may comprise wireless communication channels as well. If a plurality of different data centres are coupled by a plurality of different communication channels, the links may be combined using any of a number of techniques, including without limitation, the formation of link aggregation groups (LAGs).

In some non-limiting examples, at least some of the computing, storage, and connectivity resources (along with other resources within the network 1602) may be divided between different sub-networks, in some cases in the form of a resource slice. If the resources across a number of connected at least one of: data centres, and collections of nodes, are sliced, different network slices may be created.

The device 1600 may, in some non-limiting examples, be schematically thought of, and described, in terms of a number of functional units, each of which has been described in the present disclosure.

In some non-limiting examples, the device 1600 may communicate with at least one remote device 1600, through the network 1602. In some non-limiting examples, the remote device 1600 may access the device 1600, via the network 1602.

The bus 1640 couples the components of the device 1600 to facilitate the exchange of data, programs, and other information, within the device 1600 between components thereof. The bus 1640 may comprise at least one type of bus architecture, including without limitation, a memory bus, a memory controller, a peripheral bus, a video bus, and a motherboard.

The storage unit 1650 is one of: a storage device that may, in some non-limiting examples, comprise at least one of: a solid state memory device, a FLASH memory device, a solid state drive, a hard disk drive, a magnetic disk drive, a magneto-optical disk, an optical memory, and an optical disk drive, and a data repository, for storing at least one of: data, including without limitation, user data, including without limitation, at least one of: user preferences, and user programs, and files, including without limitation, at least one of: drivers, libraries, and saved programs.

In some non-limiting examples, the storage device 1650 may be distinguished from the memory 1620 in that it may perform storage tasks compatible with at least one of: higher latency, and reduced volatility. In some non-limiting examples, the storage device 1650 may be integrated with a heterogeneous memory 1620. In some non-limiting examples, the storage device 1650 may be external to, and remote from, the device 1600 and accessible through use of the network interface 1630.

The video adapter 1660, including without limitation, an electronic display adapter, provides interfaces to couple the device 1600 to external input and output (I/O) devices, including without limitation, one of: a display 1604, a monitor, a liquid crystal display (LCD), and a light-emitting diode (LED), coupled therewith.

In some non-limiting examples, the display 1604 may comprise a user interface (UI), including without limitation, a graphical user interface (GUI), and a web-based UI, for managing and organizing at least one of: inputs provided to, and outputs generated by the display 1604 including without limitation, at least one of: results, and solutions, to the problems described herein.

The peripheral interface 1670, including without limitation, at least one of: a parallel interface, and a serial interface, including without limitation, a universal serial bus (USB) interface, provides interfaces to couple other I/O devices, including without limitation, an input part of the display 1604, a touch screen, a printer, a keyboard, a keypad, a switch, a dial, a mouse, a trackball, a track pad, a biometric recognition (and input) device, a card reader, a paper tape reader, a camera, a sensor, a peripheral device, and a memory 920, coupled therewith.

In some non-limiting examples, the device 1600 may be embodied as at least (part of) one of: a personal computer (PC), a desktop computer, a computer workstation, a mini computer, a mainframe computer, a laptop, and a mobile electronic device, including without limitation, a tablet (slate) PC (including without limitation, at least one of: Apple iPad and Samsung® Galaxy Tab), a mobile telephone (including, without limitation, a smartphone (including without limitation, at least one of: Apple® iPhone, Android-enabled device, and Blackberry® device), an e-reader, and a personal digital assistant).

Other components, as well as related functionality, of the device 900, may have been omitted in order not to obscure the concepts presented herein.

In general terms, each functional unit of the present disclosure may be implemented in at least one of: hardware, software, and firmware as the context dictates. The processor 1610 may thus be arranged to fetch instructions from at least one of the memory 1620 and the storage unit 1650, as provided by a functional unit of the present disclosure, to execute these instructions, thereby performing any of at least one of: an action, and an operation, as were described herein.

Aspects of the systems and methods provided herein, including without, the device 1600, may be embodied in programming. Various aspects of the technology may be thought of as one of: “products”, and “articles of manufacture”, typically in the form of at least one of: machine-executable instructions, including without limitation, processor-executable instructions, and associated data, that is one of: carried on, and embodied in, a type of machine-readable medium.

In some non-limiting examples, “storage”-type media may include the tangible memory of the device 1600, including without limitation, the processor 1610, and associated modules thereof, including without limitation, at least one of: various semiconductor memories, tape drives, and disk drives, of at least one of the memory 1620, and the storage unit 1650, which may provide non-transitory storage at any time for the software programming. In some non-limiting examples, one of: all, and parts, of the software may at times be communicated through the network 1602. In some non-limiting examples, such communications may enable loading of the software from one computer, including without limitation, the device 1600, including without limitation, a processor 1610 thereof, into another computer, including without limitation, a processor 1610 thereof, including without limitation, from one of: a management server, and a host computer, into the computer platform of an application server.

In some non-limiting examples, “storage”-type media that may bear the software elements of at least one functional unit of the present disclosure, may include at least one of: optical, electrical, and electromagnetic (EM) signals, including without limitation, such signals, including without limitation, waves, used across physical interfaces between local devices, through at least one of: wired, including without limitation, a baseband signal, and optical, landline networks, and over various air-links including without limitation, a signal embodied in a carrier wave. The physical elements that carry such signals, including without limitation, at least one of: the wired links, including without limitation, electrical conductors, including without limitation, coaxial cables, and waveguides, wireless links, including without limitation, those propagating through at least one of; the air and free space, and optical links including without limitation, optical media, including without limitation, optical fibre, also may be considered as “storage”-type media bearing the software.

As used herein, unless expressly restricted to non-transitory, tangible “storage” media, terms, including without limitation, one of: “computer-readable medium”, and “machine-readable medium” may refer to any medium that participates in providing instructions to a processor 1610 for execution. Such signals, including without limitation, other types of signals, including without limitation, those currently used and hereafter developed, referred to herein as the transmission medium, may be generated according to several well-known methods.

In some non-limiting examples, the information contained in such signals may be ordered according to different sequences, suitable for at least one of: processing, and generating the information, and receiving the information.

In some non-limiting examples, a machine-readable medium, including without limitation, computer-executable code, may take many forms, including without limitation, at least one of: a tangible storage medium, a carrier wave medium, and a physical transmission medium.

In some non-limiting examples, non-volatile storage media may comprise one of: optical, and magnetic, disks, including without limitation, any of the storage devices 1620, 1650 in any device(s) 1600, including without limitation, one that may be used to implement the databases and at least some other associated components shown in the drawings.

In some non-limiting examples, volatile storage media may comprise dynamic memory, including without limitation, main memory 1620 of such a device 1600.

In some non-limiting examples, tangible transmission media may comprise at least one of: coaxial cables, copper wires, and fiber optics, including without limitation, the wires that comprise a bus 1640 within a device 1600.

In some non-limiting examples, carrier-wave transmission media may take the form of one of: electric signals, electromagnetic signals, acoustic waves, and light waves, including without limitation, those generated during radio frequency (RF) and infrared (IR) data communication.

Non-limiting example forms of computer-readable media include at least one of: a floppy disk, a flexible disk, a hard disk, a magnetic tape, any other magnetic medium, a CD-ROM, a DVD, a DVD-ROM, any other optical medium, punch cards, paper tape, any other physical storage medium with patterns of holes, a RAM, a ROM, a PROM, an EPROM, an EEPROM, a FLASH-EPROM, any other one of: a memory chip, and cartridge, a carrier wave transporting one of: data, and instructions, one of: cables, and links, transporting such a carrier wave, and any other medium from which a device 1600 may read one of: programming code, and data. In some non-limiting examples, many of these forms of computer-readable media may be involved in carrying out at least one sequence of at least one instruction to a processor 1610 for execution.

### Electrical Terms

The present disclosure can be implemented in at least one of: digital electronic circuitry, computer hardware, firmware, and software, and in combination thereof. Apparatus of the disclosure can be implemented in a computer program product tangibly embodied in a machine-readable storage device for execution by a programmable processor; and methods and actions can be performed by a programmable processor executing a program of instructions to perform functions of the disclosure by operating on input data and generating output.

The disclosure can be implemented advantageously on a programmable system including at least one input device, and at least one output device.

In some instances, detailed descriptions of well-known devices, circuits and methods are omitted so as not to obscure the description of the present disclosure with unnecessary detail.

### General Terms

In the foregoing disclosure, for purposes of explanation and not limitation, specific details are set forth in order to provide a thorough understanding of the present disclosure.

Having described in detail examples that are in accordance with the present disclosure, it is noted that the embodiments reside primarily in combinations of apparatus components and processing actions related to manufacturing composite resilient members.

Accordingly, the system and method components have been represented where appropriate by conventional symbols in the drawings, showing only those specific details that are pertinent to understanding the examples of the present disclosure, so as not to obscure the disclosure with details that will be readily apparent to those of ordinary skill in the art having the benefit of the description herein.

Moreover, an article of manufacture for use with the apparatus, such as one of: a pre-recorded storage device, other similar computer readable medium including program instructions recorded thereon, and a computer data signal carrying computer readable program instructions, may direct an apparatus to facilitate the practice of the described methods. It is understood that such apparatus, articles of manufacture, and computer data signals, also come within the scope of the present disclosure.

While the present disclosure is sometimes described in terms of methods, a person of ordinary skill in the art will understand that the present disclosure is also directed to various apparatus including components for performing at least one of the aspects and features of the described methods, be it by any one of: hardware components, and software, and+ in any other manner.

### Terminology

References in the singular form may include the plural and vice versa, unless otherwise noted.

As used herein, relational terms, such as “first” and “second”, and numbering devices such as “a”, “b” and the like, may be used solely to distinguish one entity/element from another entity/element, without necessarily requiring/implying any physical/logical relationship/order between such entities/elements.

The terms “including” and “comprising” may be used expansively and in an open-ended fashion, and thus should be interpreted to mean “including, but not limited to”. The terms “example” and “exemplary” may be used simply to identify instances for illustrative purposes and should not be interpreted as limiting the scope of the invention to the stated instances. In some non-limiting examples, the term “exemplary” should not be interpreted to denote/confer any laudatory, beneficial, and other quality to the expression with which it is used, whether in terms of design, performance and otherwise.

Further, the term “critical”, especially when used in the expressions “critical nuclei”, “critical nucleation rate”, “critical concentration”, “critical cluster”, “critical monomer”, “critical particle structure size”, and “critical surface tension” may be a term familiar to those having ordinary skill in the relevant art, including as relating to/being in a state in which a measurement/point at which some at least one of: quality, property and phenomenon undergoes a definite change. As such, the term “critical” should not be interpreted to denote/confer any significance/importance to the expression with which it is used, whether in terms of design, performance, and otherwise.

The terms “couple” and “communicate” in any form may be intended to mean either one of: a direct, and indirect, connection through some one of: an interface, device, intermediate component, connection, whether optically, electrically, mechanically, chemically, and otherwise.

The terms “on” and “over”, when used in reference to a first component relative to another component, and at least one of: “covering” and which “covers” another component, may encompass situations where the first component is directly on (including without limitation, in physical contact with) the other component, as well as cases where at least one intervening component is positioned between the first component and the other component.

Directional terms such as “upward”, “downward”, “left” and “right” may be used to refer to directions in the drawings to which reference is made unless otherwise stated. Similarly, words such as “inward” and “outward” may be used to refer to directions toward and away from, respectively, the geometric center of the device, area, volume and designated parts thereof. Moreover, all dimensions described herein may be intended solely to be by way of example of purposes of illustrating certain examples and may not be intended to limit the scope of the disclosure to any examples that may depart from such dimensions as may be specified.

As used herein, the terms “substantially”, “substantial”, “approximately”, and “about” may be used to denote and account for small variations. When used in conjunction with an event/circumstance, such terms may refer to instances in which the event/circumstance occurs precisely, as well as instances in which the event/circumstance occurs to a close approximation. In some non-limiting examples, when used in conjunction with a numerical value, such terms may refer to a range of variation of no more than about +10% of such numerical value, such as at least one of no more than about: +5%, +4%, +3%, +2%, +1%, +0.5%, +0.1%, and +0.05%.

As used herein, the phrase “consisting substantially of” may be understood to include those elements specifically recited and any additional elements that do not materially affect the basic and novel characteristics of the described technology, while the phrase “consisting of” without the use of any modifier, may exclude any element not specifically recited.

Whenever the term “at least” precedes the first numerical value in a series of a plurality numerical values, the term “at least” may apply to each of the numerical values in that series of numerical values. In some non-limiting examples, at least one of: 1, 2, and 3 may be equivalent to at least one of: at least 1, at least 2, and at least 3.

Whenever the term “no more than” precedes the first numerical value in a series of a plurality of numerical values, the term “no more than” may apply to each of the numerical values in that series of numerical values. In some non-limiting examples, no more than: 3, 2, and 1 may be equivalent to no more than 3, no more than 2, and no more than 1.

Certain examples herein contemplate numerical ranges. When ranges are present, the ranges may include the range endpoints. Additionally, every sub-range and value within the range may be present as if explicitly written out. The terms “about” and “approximately” may mean within an acceptable error range for the particular value, which will depend in part on how the value is measured (determined), including without limitation, the limitations of the measurement system. In some non-limiting examples, “about” may mean within one of: 1, and more than 1, standard deviation, per the practice in the relevant art. In some non-limiting examples, “about” may mean a range of one of no more than about: 20%, 10%, 5%, and 1% of a given value. Where particular values are described in the application and claims, unless otherwise stated the term “about” meaning within an acceptable error range for the particular value may be assumed.

As will be understood by those having ordinary skill in the relevant art, for any and all purposes, particularly in terms of providing a written description, all ranges disclosed herein may also encompass any and all possible sub-ranges, and combinations of sub-ranges thereof. Any listed range may be easily recognized as substantially describing/enabling the same range being broken down at least into equal fractions thereof, including without limitation, halves, thirds, quarters, fifths, tenths etc. As a non-limiting example, each range discussed herein may be readily be broken down into a lower third, middle third, and upper third, etc.

As will be understood by those having ordinary skill in the relevant art, for any and all purposes, particularly in terms of providing a written description, all values/ranges disclosed herein that are described in terms of at least one decimal value, should be interpreted as encompassing a value/range that includes rounding error as would be understood by those having ordinary skill in the art, as determined based on the number of significant digits expressed by such decimal value. For greater certainty, the presence/absence of any additional decimal value, in the present disclosure, the same paragraph, and even the same sentence, as the first decimal value, which may have a greater/lesser number of significant digits than the first decimal value, should not be used to limit the value/range encompassed by such first decimal value, in any fashion that limits the value/range so encompassed, to a value/range that is no more than one that includes rounding error based on the number of significant digits expressed thereby.

As will also be understood by those having ordinary skill in the relevant art, all language/terminology such as “up to”, “at least”, “at least”, “no more than”, “no more than”, and the like, may include/refer the recited range(s) and may also refer to ranges that may be subsequently broken down into sub-ranges as discussed herein.

As will be understood by those having ordinary skill in the relevant art, a range may include each individual member of the recited range.

### General

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

Certain terms are used throughout to refer to particular components. Manufacturers may refer to a component by different names. Use of a particular term or name is not intended to distinguish between components that differ in name but not in function.

The purpose of the Abstract is to enable the relevant patent office and the public generally, and specifically, persons of ordinary skill in the art who are not familiar with patent/legal terms/phraseology, to quickly determine from a cursory inspection, the nature of the technical disclosure. The Abstract is neither intended to define the scope of this disclosure, nor is it intended to be limiting as to the scope of this disclosure in any way.

All publications, patents, and patent applications mentioned in this specification are herein incorporated by reference to the same extent as if each individual one of: a publication, patent, and patent application, was specifically and individually indicated to be incorporated by reference. To the extent publications, patents, and patent applications incorporated by reference contradict the disclosure contained in the specification, the specification is intended to one of: supersede, and take precedence over, any such contradictory material,

Incorporation by reference is expressly limited to the technical aspects of the materials, systems, and methods described in the mentioned publications, patents, and patent applications and may not extend to any lexicographical definitions from the publications, patents, and patent applications. Any lexicographical definition appearing in the publications, patents, and patent applications that is not also expressly repeated in the instant disclosure should not be treated as such and should not be read as defining any terms appearing in the accompanying claims.

The structure, manufacture and use of the presently disclosed examples have been discussed above. The specific examples discussed are merely illustrative of specific ways to make and use the concepts disclosed herein, and do not limit the scope of the present disclosure. Rather, the general principles set forth herein are merely illustrative of the scope of the present disclosure.

It should be appreciated that the present disclosure, which is described by the claims and not by the implementation details provided, and which can be modified by varying, omitting, adding, replacing, and in the absence of, any element(s), at least one of: limitation(s) with alternatives, and equivalent functional elements, whether specifically disclosed herein, will be apparent to those having ordinary skill in the relevant art, and may be made to the examples disclosed herein, and may provide many applicable inventive concepts that may be embodied in a wide variety of specific contexts, without straying from the present disclosure.

In some non-limiting examples, features, techniques, systems, sub-systems and methods described and illustrated in at least one of the above-described examples, whether described and illustrated as discrete/separate, may be combined/integrated in another system without departing from the scope of the present disclosure, to create alternative examples comprised of a (sub-) combination of features that may not be explicitly described above, including without limitation, where certain features may be omitted/not implemented. Features having applicability for such combinations and sub-combinations would be readily apparent to persons skilled in the art upon review of the present application as a whole. Other examples of changes, substitutions, and alterations are easily ascertainable and could be made without departing from the spirit and scope disclosed herein.

All statements herein reciting principles, aspects, and examples of the disclosure, as well as specific examples thereof, are intended to encompass both structural and functional equivalents thereof and to cover and embrace all applicable changes in technology. Additionally, it is intended that such equivalents include both currently known equivalents as well as equivalents developed in the future, i.e., any elements developed that perform the same function, regardless of

While examples are disclosed, this is not intended to be limiting. Rather, the general principles set forth herein are considered to be merely illustrative of the scope of the present disclosure.

It will be apparent that various modifications and variations covering alternatives, modifications and equivalents may be made to the embodiments disclosed herein, without departing from the spirit and scope of the present disclosure, as defined by the appended claims.

For example, the various elements or components may be combined or integrated in another system or certain features may be omitted, or not implemented. Also, techniques, systems, subsystems and methods described and illustrated in the various embodiments as discrete/separate may be combined/integrated with other systems, modules, techniques, and methods without departing from the scope of the present disclosure. Other examples of changes, substitutions, and alterations are easily ascertainable and could be made without departing from the spirit and scope disclosed herein.

In particular, features from at least one of the above-described embodiments may be selected to create alternative embodiments comprised of a sub-combination of features that may not be explicitly described above. In addition, features from at least one of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

Other embodiments consistent with the present disclosure will be apparent from consideration of the specification and the practice of the disclosure disclosed therein. Accordingly the specification and the embodiments disclosed therein are to be considered examples only, with a true scope and spirit of the disclosure being disclosed by the following numbered claims:

What is claimed is:

1. A method of arranging for authorization of an item, comprising actions of:
creating an item request record, comprising information related to an item;
digitally signing the item request record;
confirming the digital signature of the item request record;
submitting an authorization request associated with the item, for authorization by at least one authorizer;
securing authorization of the authorization request by the at least one authorizer;
generating an authorized item request digitally signed by the at least one authorizer; and
validating the digital signature of a next authorizer in the authorization item request until the digital signature(s) of all of the at least one authorizers have been validated.

2. The method of claim 1, wherein the information related to the item request comprises at least one of: information identifying an initiator, information identifying a recipient, and information identifying the item.

3. The method of claim 1, wherein the action of creating is performed by the initiator.

4. The method of claim 1, wherein the item request record is stored on a storage device.

5. The method of claim 1, comprising an action of providing the item request record to the authorization software.

6. The method of claim 5, wherein the action of providing precedes the action of confirming.

7. The method of claim 1, wherein the action of digitally signing comprises an action of encrypting the item request record with a cryptographic key of an initiator of the item request record.

8. The method of claim 7, wherein the cryptographic key is one of: a private key in an asymmetric key approach, and a symmetric key in a symmetric key approach.

9. The method of claim 1, wherein the action of digitally signing comprises an action of hashing the item request record.

10. The method of claim 1, comprising an action of associating the digital signature of the item request record with the item request record.

11. The method of claim 1, wherein the action of confirming comprises an action of decrypting the digital signature of the item request payload to generate a decryption result thereof.

12. The method of claim 1, wherein the authorization request comprises the item request record, the digital signature thereof, and a list of the at least one authorizer(s).

13. The method of claim 12, wherein the list is based on a policy establishing at least one item authorization rule.

14. The method of claim 1, wherein the action of securing comprises an action of authorizing the authorization request by digitally signing the authorization request.

15. The method of claim 1, wherein the action of authorizing comprises an action of encrypting the item authorization record with a cryptographic key of the authorizer.

16. The method of claim 1, wherein the action of authorizing comprises an action of hashing the item authorization record.

17. A secure authorization system for authorizing an item comprising a processor, and a computer readable and executable medium for containing instructions that, when executed by the processor, cause the system to perform actions of:
creating an item request record, comprising information related to an item;
digitally signing the item request record;
confirming the digital signature of the item request record;
submitting an authorization request associated with the item, for authorization by at least one authorizer;
securing authorization of the authorization request by the at least one authorizer;
generating an authorized item request digitally signed by the at least one authorizer; and
validating the digital signature of a next authorizer in the approved item request until the digital signature(s) of all of the at least one authorizers have been validated.
